(19) United States
(12) Patent Application Publication
(10) Pub. No.: US 2007/0014514 A1
(43) Pub. Date: Jan. 18, 2007

(54) Optical component

(75) Inventor: Yunqu Liu, Kanata (CA)

Correspondence Address: FREEDMAN & ASSOCIATES, 117 CENTREPOINTE DRIVE, SUITE 350, NEPEAN, ONTARIO, K2G 5X3, CA

(73) Assignee: Viscore Technologies Inc., Kanata (CA)

(21) Appl. No.: 11/473,163

(22) Filed: Jun. 23, 2006

Related U.S. Application Data
(60) Provisional application No. 60/693,074, filed on Jun. 23, 2005.

(51) Int. Cl. G02B 6/28

(52) U.S. Cl. 385/24; 385/14

(57) ABSTRACT

An optical device featuring a first wavelength division multiplexer, an isolator and a second wavelength division multiplexer is described. The isolator supports the propagation of optical signals within a predetermined signal wavelength range in one direction. Pump signals having a wavelength within a pump wavelength range are diverted by the wavelength division multiplexers to inhibit coupling of the pump signals with the isolator.

This application claims benefit from U.S. Provisional Patent Application No. 60/693,074 filed Jun. 23, 2005 the entire contents of which are incorporated herein by reference.

### FIELD OF THE INVENTION

The invention relates to optical fibre communication systems. More specifically, the invention relates to optical amplifiers such as erbium doped fibre amplifiers (EDFA), yttrium doped fibre amplifiers (YDFA) and hybrid optical components for use in optical amplifiers.

### BACKGROUND

One of the key advantages of modern optical communications systems is that a single optical waveguide is able to support a variety of distinct optical signals, each having a somewhat different characteristic wavelength range. Further, when the optical signals are provided in a same wavelength communication band a single optical amplifier supports the amplification of each of these signals individually. The deployment of this technology has facilitated a reduction in cost of transmitting data over long distances. In U.S. Pat. No. 5,535,050 by Suyama an optical amplifier featuring “an optical fiber which may be doped with a rare earth element.” (reference Abstract of Suyama.)

Optical amplifiers support a variety of complex optical networking devices. For example in U.S. Pat. No. 6,424,445 by Tsushima et al. optical amplifiers are used to support an optical repeater featuring an optical cross-connect. The device of Tsushima et al. clearly demonstrates that optical amplifiers have uses that are not restricted to propagating optical data over long distances.

Unfortunately, the cost of optical amplifiers, such as erbium doped fibre amplifiers (EDFA) and yttrium doped fibre amplifiers (YDFA) is still very high because a variety of the components used in their design remain difficult to produce commercially.

It would be beneficial to provide a less expensive optical amplifier that provides higher reliability than conventional EDFAs and YDFAs with comparable performance.

### SUMMARY OF THE INVENTION

The invention teaches an apparatus comprising: a first WDM comprising a first input port for receiving a signal comprising a pump signal having a characteristic wavelength within a pump laser wavelength range and a signal of interest having a characteristic wavelength range within a signal wavelength range, a first output port coupled to a first optically transmissive path, and a second output port coupled to a second optically transmissive path, the first WDM for optically coupling signals within the pump laser wavelength range between the first input port and the first output port; a second WDM comprising a second input port, a third output port coupled to the first optically transmissive path, and a fourth output port coupled to the second optically transmissive path, the second WDM for optically coupling signals within the pump laser wavelength range between the second input port and the third output port; and, an optical isolator comprising an isolator input port and an isolator output port, the optical isolator optically disposed within the second optically transmissive path, for propagating optical signals within the signal wavelength range from the isolator input port to the isolator output port and for attenuating optical signals having wavelengths within the signal wavelength range incident the isolator output port.

The invention supports A method comprising: receiving an external optical signal and an optical pump signal incident a same input port; separating the external optical signal and the optical pump signal using a first wavelength division multiplexer (WDM); isolating the external optical signal using an optical isolator optically coupled to the WDM; receiving the isolated external optical signal and re-combining it with the optical pump signal using a second WDM that is optically coupled to the isolator; and, providing the isolated external optical signal and the optical pump signal at an output port.

### BRIEF DESCRIPTION OF THE DRAWINGS

The invention is now described with reference to the drawings in which:

FIG. 1 is a simplified diagram of a prior art optical amplifier with a single pump laser;

FIG. 2 is a simplified diagram of a prior art optical amplifier featuring two separate pump lasers;

FIG. 3 is a schematic diagram of a hybrid optical component according to a first embodiment of the invention;

FIG. 4 is a simplified diagram of an optical amplifier featuring the hybrid of FIG. 3;

FIG. 5 is a simplified diagram of an optical amplifier featuring a hybrid according to a second embodiment of the invention;

FIG. 6 is a simplified diagram of an optical amplifier featuring two of the hybrids according to FIG. 3; and,

FIG. 7 is a simplified diagram of the optical amplifier of FIG. 6 with optical filters for reducing noise.

### DETAILED DESCRIPTION OF EMBODIMENTS OF THE INVENTION

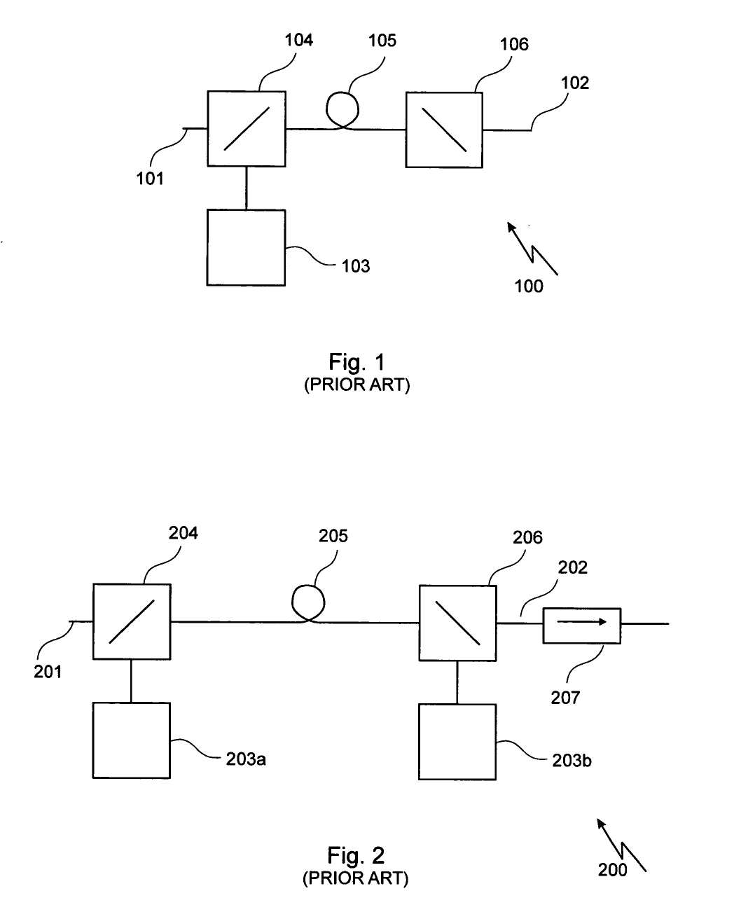

Referring to FIG. 1, a prior art optical amplifier 100 is shown. The optical amplifier 100 comprises: an input port 101, an output port 102, a pump laser 103, a first wavelength division multiplexer (WDM) 104, a length of doped fibre 105 and a second WDM 106. In use, an input optical signal is provided incident the input port 101. The input optical signal has a wavelength within a predetermined first wavelength range. Optionally, the input optical signal is a wavelength division multiplexed signal comprising component signals, each having a wavelength with a non-overlapping characteristic wavelength range within the predetermined first wavelength range. The input optical signal is coupled to a waveguide that supports the propagating of the input optical signal to the first WDM 104. The pump laser 103 provides a pumping optical signal having a second wavelength range, the second wavelength range not overlapping the first wavelength range. The WDM 104 combines these two optical signals and provides them to the doped fibre 105. The doped fibre 105 is optionally one of an erbium doped fibre and a yttrium doped fibre. The two optical signals propagate within the doped fibre 105. Molecules within the doped fibre 105 absorb energy from the pumping optical signal. These molecules, having absorbed energy from the pumping optical signal become highly energized. The energized molecules dissipate some of this energy to the input optical signal resulting in an amplification of the input optical signal. The amplified optical signal propagates to the second WDM 106. The second WDM 106 is chosen to couple the amplified optical signal to the output port 102 while preventing the pumping optical signal from propagating to the output port 102. Typically, the pumping optical signal has a lower wavelength than the optical signal being amplified. For example, it is known to pump a 1310 nm optical signal with a 980 nm pump signal. A person of ordinary skill in the art will be aware of other wavelength combinations that are suitable for use with conventional optical amplifiers. One drawback to the prior art device of FIG. 1 is that the amount of amplification is insufficient in some applications. Thus, in many cases it is desired to provide more amplification to the input optical signal than would be practical given a single optical amplifier. One obvious option to overcome this problem is to provide two optical amplifiers according to FIG. 1 in which the output port of a first optical amplifier is optically coupled to the input port of the second optical amplifier. While this is sufficient in some cases, it is clear that such a solution is also quite expensive as the cost of optical amplifiers is often prohibitive to their use.

The amount of power transferred from a pumping optical signal to an external optical signal is practically limited due to noise that frequently occurs in doped fibre amplifiers. Specifically, while statistically rare, occasionally, a highly energized molecule within the doped fibre provides an optical signal at a wavelength consistent with the optical signal being amplified while no such optical signal is present. Thus, it is known that a doped fibre amplifier will contribute a certain amount of optical noise to an optical signal being amplified. The real problem with this noise is that the optical amplifier does not distinguish such noise from the optical signal being amplified. Thus, the optical amplifier may amplify the noise that it generates. Further, the optical noise is as likely to propagate in either direction in the doped fibre. When this occurs it has two detrimental effects. First, it generates optical noise in the system and second, it reduces the amount of pumping energy available for the optical signal. The prior art makes efforts to address these difficulties as described with reference to FIG. 2.

The prior art teaches that a more powerful optical amplifier is optionally built using two separate pump lasers. Each of these pump lasers being used to contribute optical energy to the input optical signal. Referring to FIG. 2, a second optical amplifier 200 according to the prior art is shown. The second optical amplifier 200 comprises: an input port 201, an output port 202, a first pump laser 203a, a second pump laser 203b, a first WDM 204, a length of doped fibre 205, a second WDM 206 and an isolator 207. In use, the second optical amplifier 200 receives an input optical signal at input port 201. This optical signal propagates to the first WDM 204. The first pump laser 203a provides a first pump signal that propagates to the first WDM 204. The input optical signal and the first pump signal then propagate within the length of doped fibre 205. As described with reference to FIG. 1, a portion of the optical energy associated with the pump laser is transferred to the optical signal. The second pump laser 203b provides a second pump signal. The second pump signal propagates backwards in the length of doped fibre 205 via the second WDM 206. As described with reference to FIG. 1, a portion of the optical energy associated with the pump laser is transferred to the optical signal. In this manner the optical signal is amplified by the sum of the optical energies associated with the two pump lasers 203a and 203b. The amplified optical signal propagates to the output port 202 via the second WDM 206. The isolator 207 after the output port 202 is is disposed such that it will not impede an optical signal having a wavelength with a predetermined wavelength range propagating in the desired direction however it will act to prevent any reflected signals from subsequent elements of the optical system entering the second optical amplifier and contributing to optical noise and reduced amplifier efficiency.

Advances in pump laser design and fabrication now allow pump lasers with significantly higher output power. Unfortunately such pump lasers offer only modest benefits to a conventional optical amplifier design. Specifically, the length of doped fibre that both signals propagate within limits the amount of optical power transferred by a pump signal to another optical signal. Thus, when a high powered pump laser is inserted in the optical amplifier of FIG. 1 the length of doped fibre 105 is ideally increased to take advantage of the additional power of the high energy pump signal. If the length of doped fibre is sufficiently long to support the desired enhanced transfer of optical power to the optical signal then it is also expected that the amplified signal would begin adding significant amounts of noise to the optical signal. This noise accumulation acts to limit the amplification applied at each optical amplifier within a network. As such telecommunications pump lasers are typically of output power 200 mW whereas a pump laser for a CATV system with eased noise requirements of 4 W are not uncommon, 20 times higher.

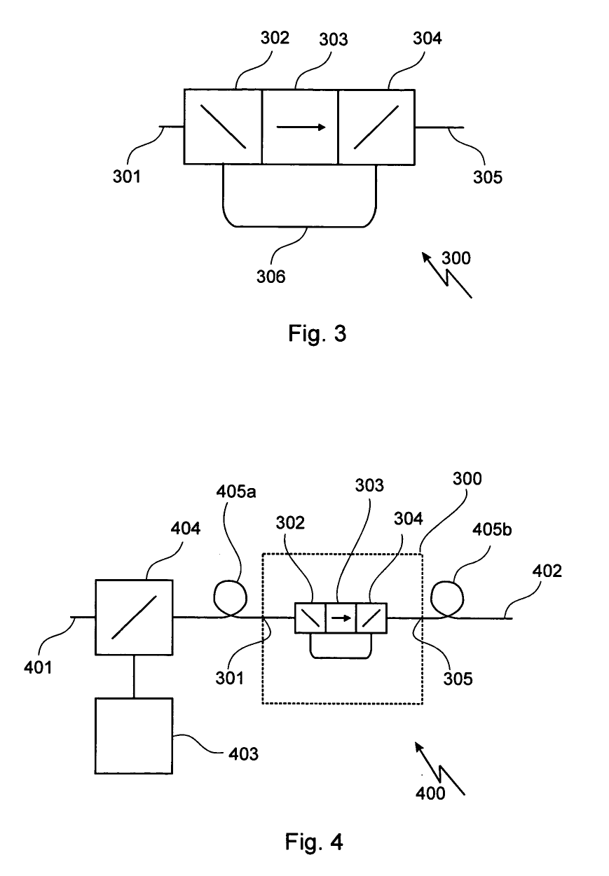

Referring to FIG. 3, a hybrid component according to a first embodiment of the invention is shown. The hybrid component 300 comprises: an input waveguide 301, a first WDM filter 302, an isolator 303, a second WDM filter 304, an output waveguide 305 and a bypass waveguide 306. In use, an input signal provided to the input waveguide 301 comprises an optical signal and a pump signal. The first WDM 302 is designed to separate the optical signal from the pump signal. Thus, the optical signal propagates through the isolator 303 and the pump signal is diverted by the first WDM 302 and propagates along the bypass waveguide 306. The optical signal propagates to the second WDM 304 via the isolator 303 and is provided to the output waveguide 305. The pump signal propagates to the second WDM filter 304 via the bypass waveguide 306. The second WDM filter 304 couples the pump signal to the output waveguide 305. In the event that a portion of the optical signal is reflected back into the output waveguide 305 then that portion will propagate along the output waveguide 305 where it will be incident the second WDM filter 304. The second WDM filter 304 couples the reflected optical signal to the isolator 303. Since the reflected optical signal is propagating in the unsupported direction of the isolator 303, the isolator 303 dissipates the reflected optical signal.

Referring to FIG. 4, an optical amplifier 400 comprising: an amplifier input port 401; an amplifier output port 402; a pump laser 403; a first length of doped fibre 405a, a second length of doped fibre 405b; a WDM 404, and a hybrid component 300 according to the first embodiment of the invention. In use, external optical signals having a wavelength corresponding to a predetermined communications band are coupled to the amplifier input port 401 and propagate to the first length of doped fibre 405a via the WDM 404. The pump laser 403 provides a pump signal at a predetermined pump signal wavelength. The pump signal propagates to the first length of doped fibre 405a via the WDM 404. A portion of the pump signal is absorbed by the first length of doped fibre 405a and transferred to the external optical signals. The length of the first length of doped fibre 405a has been chosen to provide good amplification absent sufficient length to cause problems associated with generating noise in the external optical signals. The amplified external optical signals and a remaining portion of the pump signal are provided incident the hybrid component 300. The hybrid component 300 couples the amplified external optical signals to an isolator 303 disposed therein. The isolator 303 is disposed to transmit said amplified external optical signals when they are incident the input waveguide 301. The remaining portion of the pump signal is substantially prevented from coupling to the isolator 303 by the first WDM filter 302. The remaining portion of the pump signal is then coupled to the second WDM filter 304 and provided to the output waveguide 305. The amplified external optical signal propagates from the isolator 303 to the output waveguide 305. The remaining portion of the pump signal and the amplified external optical signal are coupled to the second length of doped fibre 405b. The second length of doped fibre absorbs energy from the remaining portion of the pump signal and transfers it to the amplified external optical signal. This transfer of energy further amplifies the amplified external optical signal. In this way, the optical amplifier 400 provides high gain absent incorporation of a second pump laser. The presence of the isolator 303 within the hybrid component 300 serves to attenuate optical noise propagating opposite the correct direction in the optical amplifier 400 and therefore the intensity of back propagating optical noise is maintained at reasonable levels thereby inhibiting a tendency to amplify such noise within the first length of doped fibre 405a.

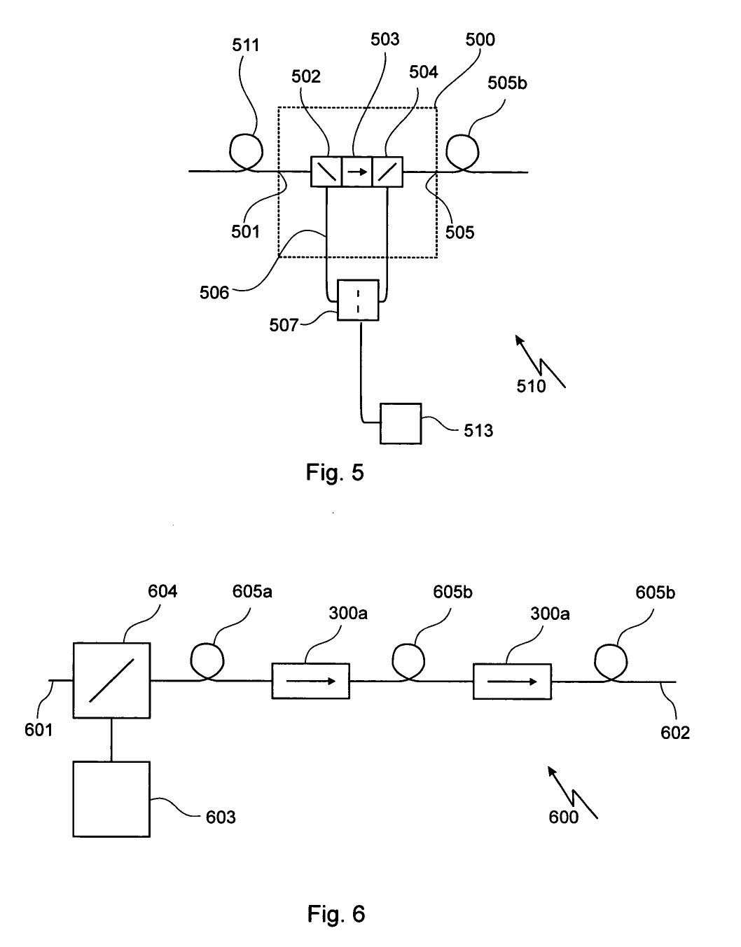

Referring to FIG. 5, a hybrid component 500 according to a second embodiment of the invention is shown in an optical amplifier 510. The hybrid component 500 comprises: an input waveguide 501, a first WDM filter 502, an isolator 503, a second WDM filter 504, an output waveguide 505, and a bypass waveguide 506. The hybrid component 500 is shown optically coupled with to a coupler 507 via the bypass waveguide 506. In addition, first and second lengths of doped optical fibre 511 and 512 are also shown. In use, a pump signal from a pump laser 513 is provided incident the coupler 507. The coupler 507 provides two separate pump signals based upon a predetermined ratio. Thus, a first portion of the pump signal propagates from the coupler 507 to the input waveguide 501 via the first WDM filter 502, and a second portion of the pump signal propagates to the output waveguide via the second WDM filter 504. An optical signal having a wavelength other than the pump wavelength provided incident the input waveguide 501 propagates to the output waveguide 505 via the first WDM filter 502, the isolator 503 and the second WDM filter 504 in that order. The optical amplifier 510 comprises a first length of doped fibre 511 and a second length of doped fibre 512. The first end of the first length of the doped fibre 511 comprises an amplifier input port and the opposite end is coupled to the input waveguide 50 1. The first end of the second length of the doped fibre 512 is coupled to the output waveguide 505 and the opposite end comprises an amplifier output port. A person of skill in the art will appreciate that in many applications it is desirable to ensure that the pumping optical signals do are inhibited from propagating outside the optical amplifier. When this is the case, it is beneficial to dispose additional optical components that serve to contain the pumping optical signals within the optical amplifier. A person of skill in the art will appreciate that this is easily accomplished by properly coupling suitably chosen WDM components optically proximate the input port and output port of the optical amplifier. Clearly, an obvious choice for such a component is a WDM filter however other components, such as a suitably oriented isolator are optionally used instead. Clearly, the choice of such components is ideally made with an understanding of the application and design criteria of the optical amplifier 510.

Referring to FIG. 6, an optical amplifier 600 featuring a pair of hybrid components 300a and 300b is shown. The hybrid components 300a and 300b are described with reference to the hybrid component 300 of FIG. 3. The optical amplifier 600 features three lengths of doped fiber 605a to 605c. The operation of the components is analogous to the operation of analogous components described with reference to FIG. 4. In the case of this optical amplifier 600, it is desired to maintain acceptable levels of optical noise. In use, an external optical signal is coupled to amplifier input port 601. This optical signal is coupled wavelength division multiplexer 604. A pump laser 603 provides a pump signal incident that wavelength division multiplexer 604. The pump signal is then coupled to the first length of doped fibre 605a. The optical signal is coupled to first length of doped fiber 605a where it is amplified when the pump laser 603 provides a pump signal. As described with reference to the first embodiment of the invention, the hybrid components 300a and 300b have a minimal effect on the pump signal and therefore, the pump signal propagates within the three lengths of doped fibre 605a to 605c and provides energy to an external optical signal as it propagates within each of the three lengths of doped fiber 605a to 605c. Optionally, the lengths of doped optical fibre 605a to 605c are shorter than those described with reference to the embodiment of FIG. 4. The reduced length of the three lengths of doped fiber 605a to 605c further reduces the amount of noise present in the doped fiber that propagates opposite the direction of propagation of the external optical signal. Based upon the design of the optical amplifier 600 of FIG. 6 a person of skill in the art will appreciate that other configurations of optical amplifiers also having very low optical noise characteristics are also supported. Specifically, a person of skill in the art may choose to further increase the number of lengths of doped fiber and optionally reduce the individual lengths of the doped fibers.

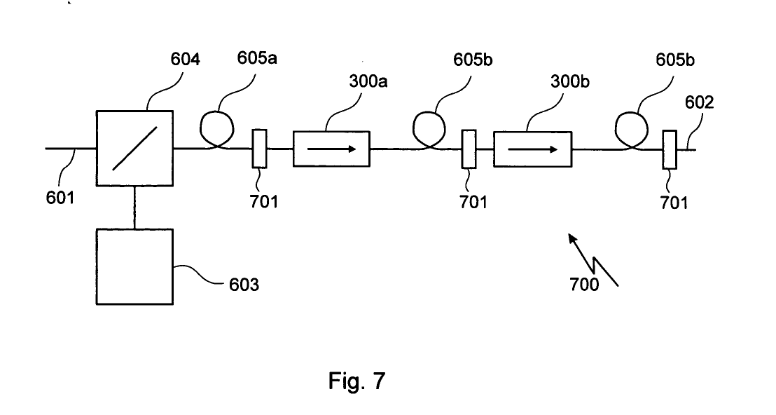

A person of skill in the art will appreciate that optical noise is often generated at the wavelengths that are not consistent with the wavelength range of the external optical signal. Referring to FIG. 7, an optical amplifier 700 featuring additional filters 701 is shown. Reference numerals present in FIG. 7 that are equivalent to those of FIG. 6 have equivalent descriptions and functionality. In many commercial applications it is desired to provide an optical amplifier for amplifying optical signals in a wavelength range of 1520 nm to 1580 nm. Such an optical amplifier will generate optical noise outside the wavelength range of the optical signals being amplified, in this case for example at 1505 nm. Such optical noise is not desirable simply because it will be amplified as it propagates within the optical amplifier, provided it propagates in the direction of propagation of the external optical signal. When the optical noise is amplified it reduces the amount of optical pumping power available to pumping the external optical signal. In order to reduce noise, filters 701 in the form of WDM components designed to separate external optical signals and pump signals from other optical signals are provided. The filters 701 allow signals propagating within the either of the predetermined ranges of wavelengths associated with pump laser and the external optical signal to propagate with minimal attenuation. Optical signals outside these two predetermined ranges are separated by the filters 701 and optionally dissipated. A person of skill in the art will appreciate that the number and location of the filters 701 is easily changed. Thus, a person of skill in the art is able to balance the cost of adding filters with the desire for reduced noise. Although the filters 701 are shown as independent components in FIG. 7 this need not be the case. Specifically, a person of skill in the art in designing optical components optionally incorporates filters 701 into the hybrid components 300a and 300b to further reduce costs. Alternatively, the filters are disposed at other locations within the optical amplifier. Clearly, the number and location of such filters 701 as well as the number and location of the hybrid components are chosen based by a person of skill in the art with the objective of providing an optical amplifier with predetermined high quality optical characteristics.

The embodiments of the invention support the use of an amplifier with a single high power pump laser. The prior art amplifier of FIG. 2 achieves many of the performance enhancements of the optical amplifiers described with reference to embodiments of the invention however, in employing multiple separate pump lasers the optical amplifier of FIG. 2 supports additional modes of failure as a failure of any of the pump lasers compromises the performance of the optical amplifier. Additionally, the cost of a high power pump source in addition to the cost the hybrid component according to the embodiments of the invention is less than the cost of two conventional pump laser sources. Thus, the amplifiers as described with reference to FIG. 4 and FIG. 5 are substantially less expensive to produce than prior art equivalents while providing enhanced reliability.

Numerous other embodiments of the invention will be apparent to one of skill in the art without departing from the spirit and scope of the invention. For example, embodiments of the invention are described as using doped fibres. A person of skill in the art will appreciate that optical amplifiers that make use of other amplifying mediums that rely on externally provided pump laser signals will also benefit from the teachings of the invention.

What is claimed is:

1. An apparatus comprising:
a first WDM comprising a first input port for receiving a signal comprising a pump signal having a characteristic wavelength within a pump laser wavelength range and a signal of interest having a characteristic wavelength range within a signal wavelength range, a first output port coupled to a first optically transmissive path, and a second output port coupled to a second optically transmissive path, the first WDM for optically coupling signals within the pump laser wavelength range between the first input port and the first output port;
a second WDM comprising a second input port, a third output port coupled to the first optically transmissive path, and a fourth output port coupled to the second optically transmissive path, the second WDM for optically coupling signals within the pump laser wavelength range between the second input port and the third output port; and, an optical isolator comprising an isolator input port and an isolator output port, the optical isolator optically disposed within the second optically transmissive path, for propagating optical signals within the signal wavelength range from the isolator input port to the isolator output port and for attenuating optical signals having wavelengths within the signal wavelength range incident the isolator output port.

2. An apparatus according to claim 1 wherein the first WDM, the second WDM and the isolator support an optical path therebetween absent optical fibre.

3. An apparatus according to claim 1 additionally comprising a coupler optically disposed within the first optically transmissive path.

4. An apparatus according to claim 2 wherein the first WDM, the second WDM and the isolator are provided as a single hybrid component.

5. An apparatus according to claim 2 wherein the first WDM, the second WDM and the isolator are provided as a single integrated optical circuit.

6. An apparatus according to claim 2 wherein the first WDM, the second WDM and a pump laser are integrated as a single integrated optical circuit.

7. An apparatus according to claim 6 wherein the isolator is integrated into the integrated optical circuit.

8. An apparatus according to claim 3 wherein the hybrid component comprises a free space optical path.

9. An apparatus according to claim 2 wherein the first optically transmissive path comprises an optical fiber.

10. An apparatus according to claim 2 wherein the signal wavelength range corresponds to a first communications band, the first communications band for supporting the propagation of optical signals between 1470 nm and 1610 nm.

11. An apparatus according to claim 2 wherein the signal wavelength range corresponds to a second communications band, the second communications band for supporting the propagation of optical signals at 1310 nm.

12. An apparatus according to claim 10 wherein the pump laser wavelength range corresponds to a wavelength range between 890 nm and 990 nm.

13. An apparatus according to claim 10 wherein the pump laser wavelength range corresponds to a wavelength range between 1415 nm and 1525 nm.

14. An apparatus according to claim 9 wherein the first input port of the first WDM is optically coupled to a first length of doped fiber.

15. An apparatus according to claim 13 wherein the second input port of the second WDM is optically coupled to a second other length of doped fiber.

16. An apparatus according to claim 15 comprising a pump laser for providing the pump signal, wherein the first WDM, the second WDM, the isolator, the first length of doped fiber and, the second length of doped fiber are disposed in a same optical amplifier.

17. An apparatus according to claim 16 wherein the first WDM, the second WDM and the isolator are disposed on a same optical path optically disposed between the first length of doped fiber and the second length of doped fiber.

18. An apparatus according to claim 17 comprising a filter for filtering optical signals at a wavelength that does not correspond to either of the pump laser wavelength range and the signal wavelength range.

19. An apparatus according to claim 17 comprising a third length of doped fiber.

20. A method comprising:
receiving an external optical signal and an optical pump signal incident a same input port;
separating the external optical signal and the optical pump signal using a first wavelength division multiplexer (WDM);
isolating the external optical signal using an optical isolator optically coupled to the WDM;
receiving the isolated external optical signal and re-combining it with the optical pump signal using a second WDM that is optically coupled to the isolator; and,
providing the isolated external optical signal and the optical pump signal at an output port.

21. A method according to claim 20 wherein the external optical signal has a wavelength within a first predetermined optical signal wavelength range and the optical pump signal has predetermined pump signal wavelength that is other than within the first predetermined optical signal wavelength range.

22. A method according to claim 20 comprising: optically propagating an optical signal from the first WDM to the second WDM via the isolator absent propagating the optical signal via an optical fibre.

23. A method according to claim 22 comprising: optically propagating a second other optical signal from the first WDM to the second WDM via an optical fibre.
